(19) United States
(12) Patent Application Publication
(10) Pub. No.: US 2015/0358343 A1
(43) Pub. Date: Dec. 10, 2015

(54) DETECTION AND CLASSIFICATION OF MALICIOUS CLIENTS BASED ON MESSAGE ALPHABET ANALYSIS

(71) Applicant: AKAMAI TECHNOLOGIES, INC., Cambridge, MA (US)

(72) Inventors: Ory Segal, Tel Aviv (IL); Adi Ludmer, Kfar Saba (IL); Tsvika Klein, Ramat Hasharon (IL)

(73) Assignee: AKAMAI TECHNOLOGIES, INC., Cambridge, MA (US)

(21) Appl. No.: 14/300,070

(22) Filed: Jun. 9, 2014

(51) Int. Cl. H04L 29/06

(52) U.S. Cl. CPC H04L 63/1425

(57) ABSTRACT

Described herein are systems, methods and apparatus for detecting and classifying malicious agents on a computer network. Many attacks require that the malicious message or messages employ certain characters. Such sets of characters can be indicative of an attack and referred to as a “malicious alphabet.” All clients on a network are likely to use characters from malicious alphabets in legitimate and valid network messages. However, malicious clients are likely to use characters from malicious alphabets in different ways than legitimate clients. According to the teachings hereof, a particular client's use of a malicious alphabet can be tracked and used to identify it as a potential attacker. Such tracking may take place across the applications and/or websites to which the traffic is directed. Based on the nature and extent of the client's use of the malicious alphabet, a reputation score for the client can be developed.

### BACKGROUND

1. Technical Field

This application generally relates to information security, to attack mitigation systems, and to client reputation systems.

2. Brief Description of the Related Art

The majority of application and network layer protection solutions rely on detecting certain attack signatures in observed traffic. For each attack class—such as a SQL injection, Remote File Inclusion, Local File Inclusion, or Cross Site Scripting—dedicated signatures are applied. As a result, new attack classes require new signatures. This means that new signatures must be developed, and then any deployed protection systems must be updated with new signature definitions. This approach is known as a negative security model.

Another approach, known as a positive security model, is to learn a normal message format for a particular application or other protected resource, and then flag anomalous messages that deviate from that standard. The protection system spends time learning what normal messages look like, typically by observing traffic for the given application, protocol, or protected resource, over some period of time. Ideally, the result is that when the trained system is applied to production traffic, it can flag anomalous messages regardless of whether they represent known or new kinds of attacks. However, the learning period can take some time to conduct and tune; moreover, if the application or other protected resource is changed, or new ones introduced, then new training may be needed. Like the negative security model, the positive security model is used in a variety of commercially available protection systems, in firewalls, intrusion detection/protection devices, and the like.

The teachings hereof improve on previous security models, and can be used not only to detect and mitigate attacks, but also to track and identify malicious network users (attackers), among other things.

### SUMMARY

Described herein are systems, methods and apparatus for detecting and classifying malicious agents on a computer network. Many attacks require that the malicious message or messages employ certain characters. Such sets of characters can be indicative of an attack and referred to as a “malicious alphabet.” All clients on a network are likely to use characters from malicious alphabets in legitimate and valid network messages. However, malicious clients are likely to use characters from malicious alphabets in different ways than legitimate clients. According to the teachings hereof, a particular client's use of a malicious alphabet can be tracked and used to identify it as a potential attacker. Such tracking may take place across the applications and/or websites to which the traffic is directed. Based on the nature and extent of the client's use of the malicious alphabet, a reputation score for the client can be developed.

The subject matter described herein has a wide variety of uses in online security. As those skilled in the art will recognize, the foregoing description merely refers to some aspects of the invention to briefly illustrate certain aspects of operation, function, and manufacture. It is not limiting and the teachings hereof may be realized in a variety of systems, methods, apparatus, and non-transitory computer-readable media.

### BRIEF DESCRIPTION OF THE DRAWINGS

The invention will be more fully understood from the following detailed description taken in conjunction with the accompanying drawings, in which:

FIG. 1 is a schematic diagram illustrating an embodiment of a system for detecting and classifying clients sending messages over a network;

FIG. 2 is a schematic diagram illustrating an embodiment of a method for detecting and classifying clients in the system shown in FIG. 1;

FIG. 3 is a schematic diagram illustrating an embodiment of a distributed computer system configured as a content delivery network;

FIG. 4 is a schematic diagram illustrating an embodiment of a machine on which a server in the system of FIG. 3 can be implemented; and,

FIG. 5 is a block diagram illustrating hardware in a computer system that may be used to implement the teachings hereof.

### DETAILED DESCRIPTION

The following description sets forth embodiments of the invention to provide an overall understanding of the principles of the structure, function, manufacture, and use of the methods and apparatus disclosed herein. All systems, methods and apparatus described herein and illustrated in the accompanying drawings are non-limiting examples; the claims alone define the scope of protection that is sought. The features described or illustrated in connection with one exemplary embodiment may be combined with the features of other embodiments. Such modifications and variations are intended to be included within the scope of the present disclosure. More specifically, any described allocation of functions to particular machines is not limiting, as the functions recited herein may be combined or split amongst different machines in a variety of ways. All patents, publications and references cited herein are expressly incorporated herein by reference in their entirety. Throughout this disclosure, the term “e.g.” is used as an abbreviation for the non-limiting phrase “for example.”

In the description that follows, clients and servers are assumed to communicate using known computer networking protocols, for example using HTTP/S at the application layer and using, among other things, the known TCP/IP networking stack. This is for illustrative purposes; the teachings hereof are not limited to any particular protocol or communication technique.

The majority of application layer attacks require that the malicious message or messages—the attack payload—employ certain characters. Put another way, each attack vector relies on the use of specific characters. For example, in SQL Injection attacks, the attacker modifies a proper query by using SQL-related characters such as semi-colon (;), dash (-), apostrophe ('), quotes (“), and so on. Similarly, in Local File Include (LFI) attacks, the attacker uses dots (.), slashes (/), backslashes (\), null bytes (\0), and others. A Cross-Site Scripting attack (XSS) involves the attacker using HTML-related characters such as angled-brackets (< >). Such sets of characters can be symptomatic and indicative of an attack, and are referred to herein as a “malicious alphabet.”

All clients on a network are likely to use characters from malicious alphabets in legitimate and valid network messages. However, malicious clients are likely to use characters from malicious alphabets differently from that of legitimate clients, for example with a different frequency and pattern. (It is noted that the term “frequency” is used not to imply periodicity in the use of the malicious alphabet, but only to reflect how often a client uses a malicious alphabet during a particular period or in a particular set of set of data.)

A particular client's use of a malicious alphabet can be tracked and, if anomalous, used to identify it as a potential attacker. Based on the nature and extent of the client's use of the malicious alphabet—possibly in combination with other characteristics such as location, overall message rate, or other behavior—a reputation score for the client can be developed, indicative of the level of confidence that the given client is in fact a malicious client.

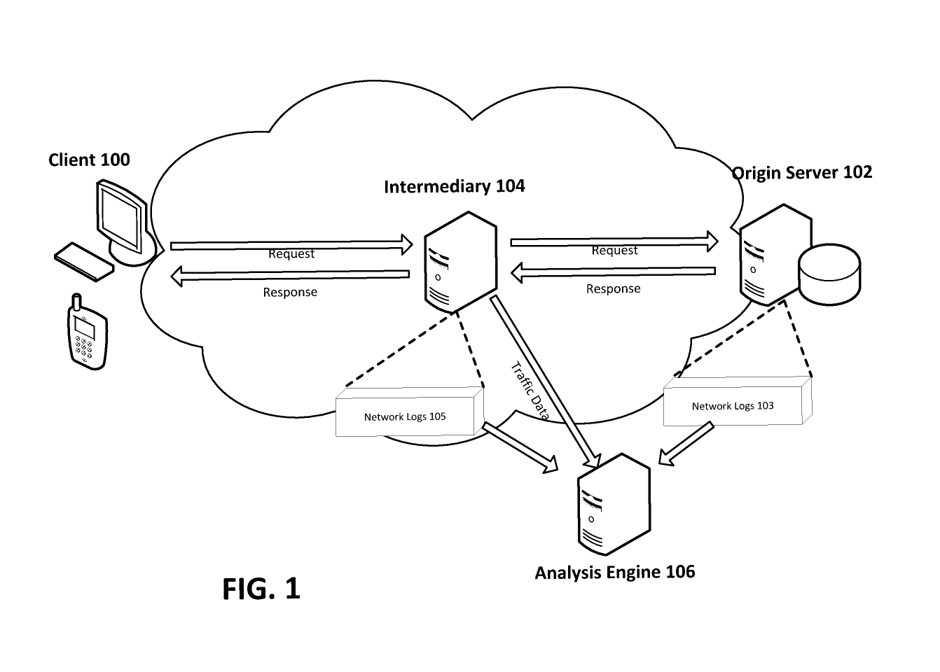

FIG. 1 illustrates one embodiment of a system for detecting and classifying network clients. A client 100 sends HTTP requests for an application resource to an origin server 102. Such requests typically seek particular data or services from an application; the requests may include information for the application to use in selecting or determining the appropriate response, such as the flight number for a flight tracking web application, or user account information for a personal banking web application. The origin server 102 is typically a web server front-end for the application infrastructure. A database (such as a SQL-compatible RDMBS system) may be used to anchor the back-end of this infrastructure. In some embodiments, the origin server 102 hosts a website providing web application functionality; in other embodiments, it might be a software platform running on the public Internet (e.g., SaaS), a server hosting an application in an enterprise network (e.g., behind the firewall application for enterprise client), or other online infrastructure.

Common web application requests use HTTP GET, POST, and PUT methods, with information submitted in URL parameters, HTTP header field, and/or HTTP body. Server-side technologies such as ASP, JSP, PHP are used to transform these submissions into back-end database queries, such as a SQL statements or other querying language. It is noted, however, the teachings hereof are not limited to any particular web application implementation.

The intermediary 104 has visibility into the messages at the application layer. Intermediary may be a device or software module (such as a module in the origin server). Non-limiting examples of the intermediary include firewalls, web application firewalls, network sniffers, intrusion detection system/instruction protection systems, deep packet inspection systems, routers, gateways, and proxies. Any network element capable of observing network traffic may be used. Preferably metrics about the traffic and in particular the use of malicious alphabets is captured in-line and sent to an out of band analysis engine 106, as shown in FIG. 1 (“traffic data”).

In one embodiment, the intermediary 104 is a reverse proxy server, such as those operative in content delivery networks. In this case, the content provider associated with the origin server typically aliases their website to the content delivery network (CDN), with the result that network clients sends messages to a selected proxy server in the CDN, seeking content or services. As noted above, the messages may contain submitted data (e.g., from HTML forms or otherwise). The proxy server typically fetches content from local cache or, upon a cache miss, generates a forward request to origin for the content, which may feed user-submitted data to the database to create an appropriate response—such as the flight status for the flight identified by the user in the form, as noted previously. The proxy then returns the response to the client. A platform of such proxies may be utilized as a network overlay to optimize communications. More information about CDN platforms is included at the end of this document.

As an alternative to examining live traffic, network logs 103, 105 of the intermediary 104 and/or content source 102 may be transmitted to and examined at the analysis engine 106 to detect and classify network clients. Any kind of data repository that might have records or visibility in network traffic can be queried for the analysis.

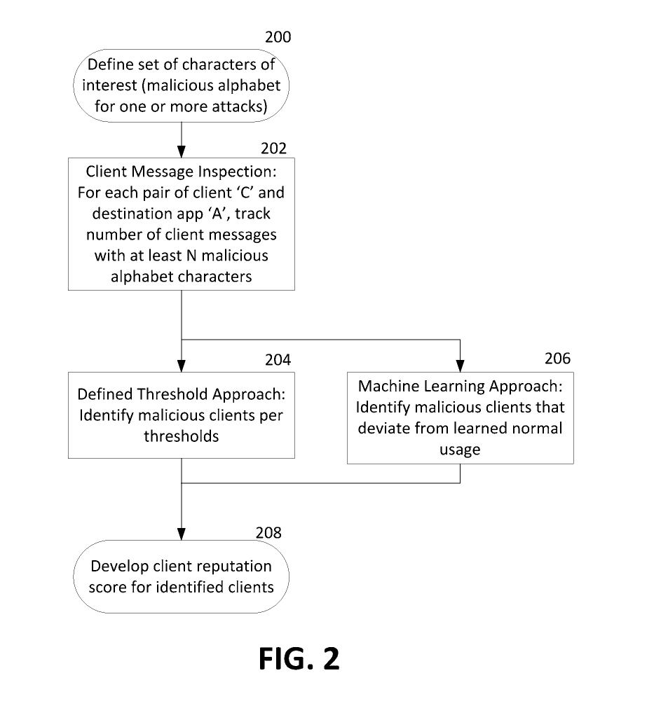

FIG. 2 illustrates an embodiment of a method for detecting and classifying network clients, preferably operative in the system shown in FIG. 1. The approach begins by defining a set of malicious alphabet characters that are of interest for the analysis (200). Preferably, each kind of attack is associated with an individual set of malicious alphabet characters, so the occurrence of each kind of attack can be tracked individually. Multiple such sets are then designated for tracking in the system (some characters may overlap across attacks, of course).

At 202, client traffic is inspected. In this embodiment, for each pair of network client C and application A to which the client is sending messages, the system tracks the number of client HTTP requests that contain at least a threshold number N of the malicious alphabet characters versus those that did not. This reveals the proportion P of messages that use at least N malicious alphabet characters. The inspection and tracking operation typically would occur, for example, at the intermediary 104 in FIG. 1, or via examination of the logs, as noted above. Typically the threshold number N is one, but this is preferably a configurable value. An example of the results of such tracking is shown below:

| | Messages with > N | Messages with ≦ N | |
|---|---|---|---|
| Client- | malicious alphabet | malicious alphabet | |
| Application | character(s) for | character(s) for | |
| Pair | current epoch | current epoch | Proportion |
| C₁A₁ | 24 | 312 | 0.07 |
| C₁A₂ | 430 | 172 | 0.71 |
| C₂A₁ | 102 | 1014 | 0.09 |
| C₃A₁ | 3 | 84 | 0.03 |
| C₃A₄ | 18 | 99 | 0.15 |

The network client can be identified by, for example, an IP address, or other identifier such as the pairing of IP Address and User-Agent, or IP Address and some session token (e.g. cookie or parameter value assigned for a specific user in a specific session), or passive transaction fingerprinting (e.g., TCP flags and HTTP headers), active fingerprinting, or otherwise. The application to which the traffic is directed can be identified, for example, by a hostname or URL, or other digital property identifier in the client's message (e.g., htttp://www.example.com/flight-tracker.jsp). Alternatively, the application may be identified by a target IP address. As those skilled in the art will understand, the malicious alphabet characters may occur in various places in the client message, depending on the web application implementation.

With 204 and 206, FIG. 2 includes two different options for performing analysis, either of which is preferably performed at the analysis engine 106. At 204, the system relies on pre-defined thresholds to identify anomalies. The system identifies and extracts the clients (e.g., by IP address) that exhibited an abnormally high proportion P of messages employing the malicious alphabet on a particular number of different applications A. For example: any client with over 50% of requests (R>0.5) containing a character from a malicious alphabet on more than five (A>5) unique applications might be considered to be a malicious client. The definition of a malicious client, which is effectively set by the thresholds, will vary with the implementation. Configuration and tuning of the system, e.g., by a system administrator, can be used to set and adjust these values.

At 206, rather than using such configured thresholds to define abnormal behavior, a machine learning approach is employed. This approach assumes a training phase is first conducted so that the system learned the ‘normal’ use that legitimate clients make of the malicious alphabet in messages, e.g., using a sample data set. This normal use can be characterized by the frequency and proportion with which legitimate clients send messages with the malicious alphabet characters and/or patterns in their use of such characters, and/or other attributes. Patterns may be seen in the locations within messages that legitimate clients tend to use the malicious alphabet characters and locations within messages that legitimate clients tend to use specific (non-malicious-alphabet) values. At 206, the trained system is applied to production traffic/log information from 202, so as to identify clients that deviate from the normal characteristics. In this way, clients that deviate from the learned norm for each of a particular number of applications A can be identified. It should be understood by those skilled in the art that the teachings hereof are not limited to any particular machine learning model; the particular parameters and attributes that are used to characterize traffic and to trigger identification of deviant/anomalous traffic will vary with the model and implementation. The inspection of the production traffic at 202 preferably parallels the machine learning model, such that the system tracks attributes of interest to the model. This may entail recording messages or portions thereof for analysis of malicious alphabet use.

At 208, the system develops a client reputation score for the clients classified as malicious, due to the results of either 204 or 206. Note that the client reputation score may be based on one or more of a variety of factors, such as:
Extent to which client exceeds malicious client thresholds in 204
Extent to which client deviates from learned norm in 206
History of client
Number of applications (A) for which client has exhibited malicious behavior, in either 204 or 206
Geographic or network location of client (derived per IP address)
History of client in past time periods
Device characteristics of client (per HTTP user-agent)
Type of attacks seen from client
Request message rate from client (raw numbers)
Persistency of attacks coming from client-in-question and similarly-behaving clients, potentially indicating a similar source

Client reputation scores can be aggregated into a database to support a wide variety of functions in a variety of online elements and platforms that may encounter the client, from firewalls to websites. For example, this database can be consulted to check such things as whether a particular client poses a threat and should be blocked; whether a client should be allowed to make a purchase on an e-commerce site, whether the client should be allowed access to a restricted/secure area on a website (e.g., as part of an authentication and authorization procedure), and others. The client reputation database can be consulted in real-time to return a reputation score to a requesting platform via a defined application provider interface (API) and/or the data can be transmitted outside of the request flow.

Preferably, where the intermediary 104 is a proxy in content delivery network platform, the client reputation information can be fed back to the proxies, and, more particularly, to a firewall function implemented therein which enforces content-provider specific firewall configurations against client traffic on behalf of content provider customers. An example of such a platform-based firewall is described in U.S. Pat. No. 8,458,769, the contents of which are hereby incorporated by reference. The teachings of that disclosure can be extended by incorporating into the firewall function a communication channel to intake client reputation and a mechanism to incorporate client reputation into a decision at the firewall as to whether to allow, deny, or alert on client traffic.

Character Sets

An example of a malicious alphabet character set for a given attack is provided below.

### SQL Injection Malicious Alphabet

Apostrophe [']
Semicolon [;]
Dash [-]
Asterisk [*]
SQL Operators [< >=!%]
Quotes [“]
Parenthesis [( )]

The foregoing SQL Injection alphabet is not necessarily intended to be definitive, but rather to be a non-limiting illustration. The character set may be revised over time, for example as attack variations are encountered, or particular characters prove to be more or less probative than others. More generally, it is possible to develop a malicious alphabet for any attack (currently existing or later-encountered) from the characters that are used to invoke that attack.

The characters in a malicious alphabet may include any computer-interpretable character used or potentially used in an attack, including both printable and non-printable characters. In one implementation, the characters are drawn from the conventional ASCII character set.

It is noted that the teachings hereof are not limited to application layer attacks. For example, network layer attacks oftentimes rely on particular byte values, such as in a buffer overflow exploitation where the ‘A’ character (0x42) is oftentimes used by attackers more often than in legitimate traffic. The same is true for ‘NOP’ (0x90). These bytes values can be designated as part of a malicious alphabet and the teachings hereof applied to detect and identify malicious clients based on them.

Content Delivery Network

As mentioned, in some cases, the intermediary 104 shown in FIG. 1 may be an element in a content delivery network. Oftentimes, a “content delivery network” or “CDN” is operated and managed by a service provider. The service provider typically provides the content delivery service on behalf of third parties. A distributed system of this type typically refers to a collection of autonomous computers linked by a network or networks, together with the software, systems, protocols and techniques designed to facilitate various services, such as content delivery or the support of outsourced site infrastructure. This infrastructure is shared by multiple tenants, the content providers. The infrastructure is generally used for the storage, caching, or transmission of content—such as web pages, streaming media and applications—on behalf of such content providers or other tenants. The platform may also provide ancillary technologies used therewith including, without limitation, DNS query handling, provisioning, data monitoring and reporting, content targeting, personalization, and business intelligence, and security services, including client reputation services.

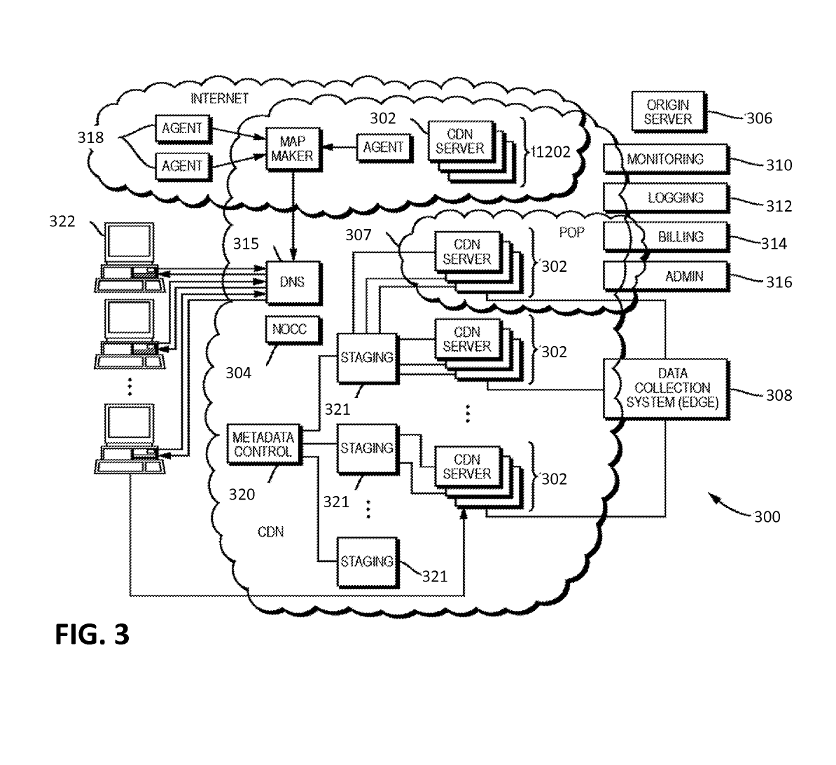

In FIG. 3, a distributed computer system 300 is configured as a CDN and has a set of servers 302 distributed around the Internet. Typically, most of the servers are located near the edge of the Internet, i.e., at or adjacent end user access networks. A network operations command center (NOCC) 304 may be used to administer and manage operations of the various machines in the system. Third party sites affiliated with content providers, such as web site origin 306, offload delivery of content (e.g., HTML or other markup language files, web application responses, embedded page objects, streaming media, software downloads, and the like) to the distributed computer system 300 and, in particular, to the CDN servers. Such servers may be grouped together into a point of presence (POP) 307 at a particular geographic location.

The CDN servers 302 are typically located at nodes that are publicly-routable on the Internet, in end-user access networks, peering points, within or adjacent nodes that are located in mobile networks, in or adjacent enterprise-based private networks, or in any combination thereof.

Typically, content providers offload their content delivery by aliasing (e.g., by a DNS CNAME) given content provider domains or sub-domains to domains that are managed by the service provider's authoritative domain name service. The server provider's domain name service directs end user client machines 322 that desire content to the distributed computer system (or more particularly, to one of the CDN servers in the platform) to obtain the content more reliably and efficiently. The CDN servers respond to the client requests, for example by fetching requested content from a local cache, from another CDN server, from the origin server 306 associated with the content provider, or other source, and sending it to the requesting client.

For cacheable content, CDN servers typically employ a caching model that relies on setting a time-to-live (TTL) for each cacheable object. After it is fetched, the object may be stored locally at a given CDN server until the TTL expires, at which time is typically re-validated or refreshed from the origin server 306. For non-cacheable objects (sometimes referred to as ‘dynamic’ content, which is often the case with web application responses), the CDN server typically returns to the origin server 306 each time when the object is requested by a client. The CDN may operate a server cache hierarchy to provide intermediate caching of customer content in various CDN servers that are between the CDN server handling a client request and the origin server 306; one such cache hierarchy subsystem is described in U.S. Pat. No. 7,376,716, the disclosure of which is incorporated herein by reference.

Although not shown in detail in FIG. 3, the distributed computer system may also include other infrastructure, such as a distributed data collection system 308 that collects usage and other data from the CDN servers and passes that data to other back-end systems 310, 312, 314 and 316 to facilitate monitoring, logging, alerts, billing, management and other operational and administrative functions. Distributed network agents 318 monitor the network as well as the server loads and provide network, traffic and load data to a DNS query handling mechanism 315. A distributed data transport mechanism 320 may be used to distribute control information to the CDN servers.

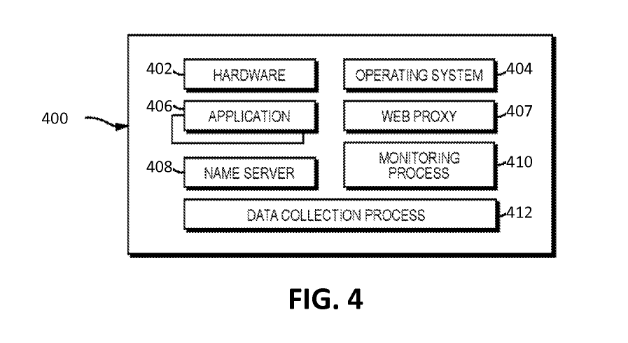

As illustrated in FIG. 4, a given machine 400 in the CDN typically comprises commodity hardware (e.g., a microprocessor) 402 running an operating system kernel (such as Linux® or variant) 404 that supports one or more applications 406. To facilitate content delivery services, for example, given machines typically run a set of applications, such as an HTTP proxy 407, a name service 408, a local monitoring process 410, a distributed data collection process 412, and the like. The HTTP proxy 407 typically includes a manager process for managing a cache and delivery of content from the machine. For streaming media, the machine may include one or more media servers, as required by the supported media formats.

A given CDN server shown in FIG. 3 may be configured to provide one or more extended content delivery features, preferably on a domain-specific, content-provider-specific basis, preferably using configuration files that are distributed to the CDN servers using a configuration system. A given configuration file preferably is XML-based and includes a set of content handling rules and directives that facilitate one or more advanced content handling features. The configuration file may be delivered to the CDN server via the data transport mechanism. U.S. Pat. No. 7,240,100, the contents of which are hereby incorporated by reference, describe a useful infrastructure for delivering and managing CDN server content control information and this and other control information can be provisioned by the CDN service provider itself, or (via an extranet or the like) the content provider customer who operates the origin server. More information about a CDN platform can be found in U.S. Pat. Nos. 6,108,703 and 7,596,619, the teachings of which are hereby incorporated by reference in their entirety.

In a typical operation, a content provider identifies a content provider domain or sub-domain that it desires to have served by the CDN. When a DNS query to the content provider domain or sub-domain is received at the content provider's domain name servers, those servers respond by returning the CDN hostname (e.g., via a canonical name, or CNAME, or other aliasing technique). That network hostname points to the CDN, and that hostname is then resolved through the CDN name service. To that end, the CDN name service returns one or more IP addresses. The requesting client application (e.g., browser) then makes a content request (e.g., via HTTP or HTTPS) to a CDN server machine associated with the IP address. The request includes a host header that includes the original content provider domain or sub-domain. Upon receipt of the request with the host header, the CDN server checks its configuration file to determine whether the content domain or sub-domain requested is actually being handled by the CDN. If so, the CDN server applies its content handling rules and directives for that domain or sub-domain as specified in the configuration.

The CDN platform may be considered an overlay across the Internet on which communication efficiency can be improved. Improved communications on the overlay can help when a CDN server needs to obtain content from an origin server 306, or otherwise when accelerating non-cacheable content for a content provider customer. Communications between CDN servers and/or across the overlay may be enhanced or improved using improved route selection, protocol optimizations including TCP enhancements, persistent connection reuse and pooling, content & header compression and de-duplication, and other techniques such as those described in U.S. Pat. Nos. 6,820,133, 7,274,658, 7,607,062, and 7,660,296, among others, the disclosures of which are incorporated herein by reference.

As an overlay offering communication enhancements and acceleration, the CDN server resources may be used to facilitate wide area network (WAN) acceleration services between enterprise data centers and/or between branch-headquarter offices (which may be privately managed), as well as to/from third party software-as-a-service (SaaS) providers used by the enterprise users.

In this vein CDN customers may subscribe to a “behind the firewall” managed service product to accelerate Intranet web applications that are hosted behind the customer's enterprise firewall (e.g., at a corporate datacenter), as well as to accelerate web applications that bridge between their users behind the firewall to an application hosted in the internet cloud (e.g., from a SaaS provider).

To accomplish these two use cases, CDN software may execute on machines (potentially in virtual machines running on customer hardware) hosted in one or more customer data centers, and on machines hosted in remote “branch offices.” The CDN software executing in the customer data center typically provides service configuration, service management, service reporting, remote management access, customer SSL certificate management, as well as other functions for configured web applications. The software executing in the branch offices provides last mile web acceleration for users located there. The CDN itself typically provides CDN hardware hosted in CDN data centers to provide a gateway between the nodes running behind the customer firewall and the CDN service provider's other infrastructure (e.g., network and operations facilities). This type of managed solution provides an enterprise with the opportunity to take advantage of CDN technologies with respect to their company's intranet, providing a wide-area-network optimization solution. This kind of solution extends acceleration for the enterprise to applications served anywhere on the Internet. By bridging an enterprise's CDN-based private overlay network with the existing CDN public internet overlay network, an end user at a remote branch office obtains an accelerated application end-to-end.

Computer Based Implementation

The subject matter described herein may be implemented with computer systems, as modified by the teachings hereof, with the processes and functional characteristics described herein realized in special-purpose hardware, general-purpose hardware configured by software stored therein for special purposes, or a combination thereof.

Software may include one or several discrete programs. A given function may comprise part of any given module, process, execution thread, or other such programming construct. Generalizing, each function described above may be implemented as computer code, namely, as a set of computer instructions, executable in one or more microprocessors to provide a special purpose machine. The code may be executed using conventional apparatus—such as a microprocessor in a computer, digital data processing device, or other computing apparatus—as modified by the teachings hereof. In one embodiment, such software may be implemented in a programming language that runs in conjunction with a proxy on a standard Intel hardware platform running an operating system such as Linux. The functionality may be built into the proxy code, or it may be executed as an adjunct to that code.

While in some cases above a particular order of operations performed by certain embodiments is set forth, it should be understood that such order is exemplary and that they may be performed in a different order, combined, or the like. Moreover, some of the functions may be combined or shared in given instructions, program sequences, code portions, and the like. References in the specification to a given embodiment indicate that the embodiment described may include a particular feature, structure, or characteristic, but every embodiment may not necessarily include the particular feature, structure, or characteristic.

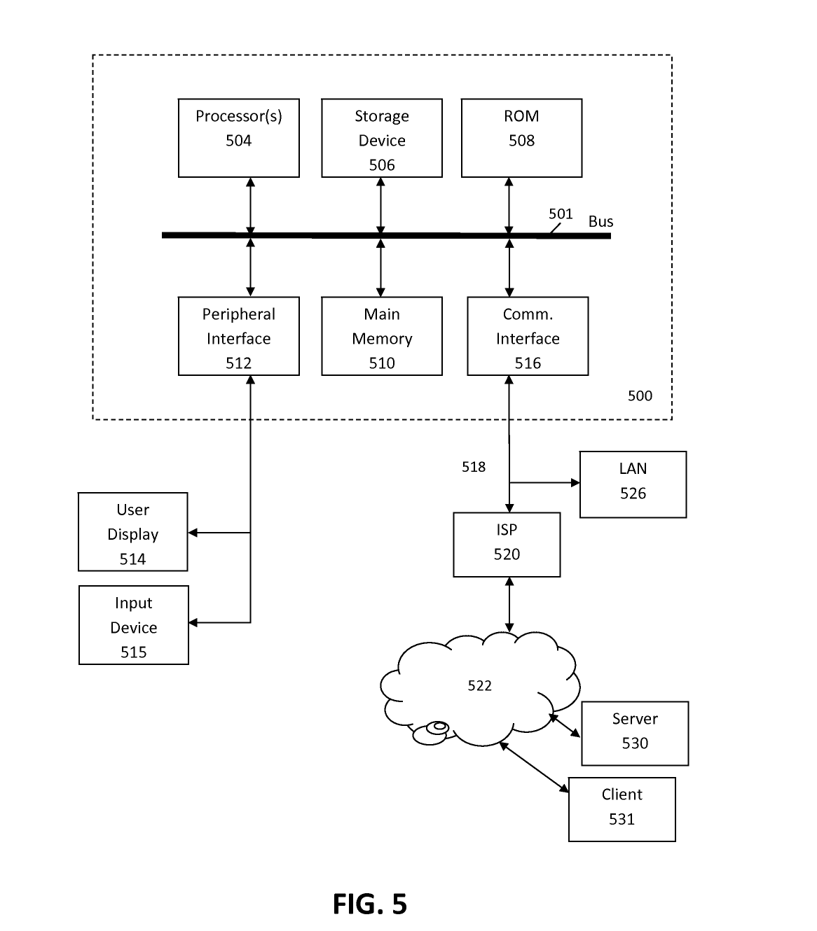

FIG. 5 is a block diagram that illustrates hardware in a computer system 500 on which embodiments of the invention may be implemented. The computer system 500 may be embodied in a client device, server, personal computer, workstation, tablet computer, wireless device, mobile device, network device, router, hub, gateway, or other device.

Computer system 500 includes a microprocessor 504 coupled to bus 501. In some systems, multiple microprocessor and/or microprocessor cores may be employed. Computer system 500 further includes a main memory 510, such as a random access memory (RAM) or other storage device, coupled to the bus 501 for storing information and instructions to be executed by microprocessor 504. A read only memory (ROM) 508 is coupled to the bus 501 for storing information and instructions for microprocessor 504. As another form of memory, a non-volatile storage device 506, such as a magnetic disk, solid state memory (e.g., flash memory), or optical disk, is provided and coupled to bus 501 for storing information and instructions. Other application-specific integrated circuits (ASICs), field programmable gate arrays (FPGAs) or circuitry may be included in the computer system 500 to perform functions described herein.

Although the computer system 500 is often managed remotely via a communication interface 516, for local administration purposes the system 500 may have a peripheral interface 512 communicatively couples computer system 500 to a user display 514 that displays the output of software executing on the computer system, and an input device 515 (e.g., keyboard, mouse, trackpad, touchscreen) that communicates user input and instructions to the computer system 500. The peripheral interface 512 may include interface circuitry and logic for local buses such as Universal Serial Bus (USB) or other communication links.

Computer system 500 is coupled to a communication interface 516 that provides a link between the system bus 501 and an external communication link. The communication interface 516 provides a network link 518. The communication interface 516 may represent an Ethernet or other network interface card (NIC), a wireless interface, modem, an optical interface, or other kind of input/output interface.

Network link 518 provides data communication through one or more networks to other devices. Such devices include other computer systems that are part of a local area network (LAN) 526. Furthermore, the network link 518 provides a link, via an internet service provider (ISP) 520, to the Internet 522. In turn, the Internet 522 may provide a link to other computing systems such as a remote server 530 and/or a remote client 531. Network link 518 and such networks may transmit data using packet-switched, circuit-switched, or other data-transmission approaches.

In operation, the computer system 500 may implement the functionality described herein as a result of the microprocessor executing program code. Such code may be read from or stored on a non-transitory computer-readable medium, such as memory 510, ROM 508, or storage device 506. Other forms of non-transitory computer-readable media include disks, tapes, magnetic media, CD-ROMs, optical media, RAM, PROM, EPROM, and EEPROM. Any other non-transitory computer-readable medium may be employed. Executing code may also be read from network link 518 (e.g., following storage in an interface buffer, local memory, or other circuitry).

A client device may be a conventional desktop, laptop or other Internet-accessible machine running a web browser or other rendering engine, but as mentioned above a client may also be a mobile device. Any wireless client device may be utilized, e.g., a cellphone, pager, a personal digital assistant (PDA, e.g., with GPRS NIC), a mobile computer with a smartphone client, tablet or the like. Other mobile devices in which the technique may be practiced include any access protocol-enabled device (e.g., iOS™-based device, an Android™-based device, other mobile-OS based device, or the like) that is capable of sending and receiving data in a wireless manner using a wireless protocol. Typical wireless protocols include: WiFi, GSM/GPRS, CDMA or WiMax. These protocols implement the ISO/OSI Physical and Data Link layers (Layers 1 & 2) upon which a traditional networking stack is built, complete with IP, TCP, SSL/TLS and HTTP. The WAP (wireless access protocol) also provides a set of network communication layers and corresponding functionality used with GSM and CDMA wireless networks, among others.

In a representative embodiment, a mobile device is a cellular telephone that operates over GPRS (General Packet Radio Service), which is a data technology for GSM networks. Generalizing, a mobile device as used herein is a 3G- (or next generation) compliant device that includes a subscriber identity module (SIM), which is a smart card that carries subscriber-specific information, mobile equipment (e.g., radio and associated signal processing devices), a man-machine interface (MMI), and one or more interfaces to external devices (e.g., computers, PDAs, and the like). The techniques disclosed herein are not limited for use with a mobile device that uses a particular access protocol. The mobile device typically also has support for wireless local area network (WLAN) technologies, such as Wi-Fi. WLAN is based on IEEE 802.11 standards. The teachings disclosed herein are not limited to any particular mode or application layer for mobile device communications.

It should be understood that the foregoing has presented certain embodiments of the invention that should not be construed as limiting. For example, certain language, syntax, and instructions have been presented above for illustrative purposes, and they should not be construed as limiting. It is contemplated that those skilled in the art will recognize other possible implementations in view of this disclosure and in accordance with its scope and spirit. The appended claims define the subject matter for which protection is sought.

It is noted that any trademarks appearing herein are the property of their respective owners and used for identification and descriptive purposes only, given the nature of the subject matter at issue, and not to imply endorsement or affiliation in any way.

1. A computer-implemented method of identifying malicious clients on a computer network, comprising:
defining a set of characters as a set of interest, the set of interest being associated with one or more attacks;
receiving a plurality of messages from a client over a computer network;
determining whether to identify the client as a malicious client based at least in part on the client's use of characters from the set of interest in the plurality of messages.

2. The method of claim 1, wherein said determining comprises:
examining the plurality of messages sent by the client to determine the proportion of messages that each contain at least a predetermined number of characters from the set of interest;
determining whether to identify the client as a malicious client based at least in part on the proportion.

3. The method of claim 2, wherein determining whether to identify the client as a malicious client comprises: comparing the proportion to a threshold value and identifying the client as a malicious client if the proportion exceeds the threshold value.

4. The method of claim 1, wherein said determining is performed using machine learning.

5. The method of claim 1, wherein the plurality of messages are, collectively, directed to a plurality of applications.

6. The method of claim 1, wherein the plurality of messages comprises application layer messages.

7. The method of claim 1, wherein the plurality of messages comprises HTTP requests.

8. The method of claim 1, further comprising: determining a client reputation score for the client based at least in part on the client's use of characters from the set of interest in the plurality of messages.

9. A computer-implemented method of identifying malicious clients on a computer network, comprising:
defining a set of characters as a set of interest, the set of interest being associated with one or more attacks;
receiving a plurality of message logs reflecting traffic sent by a client over a computer network;
determining whether to identify the client as a malicious client based at least in part on the client's use of characters in the set of interest as reflected in the plurality of message logs.

10. The method of claim 9, wherein said determining comprises:
examining the plurality of message logs to determine the proportion of messages that each contain at least a predetermined number of characters from the set of interest;
determining whether to identify the client as a malicious client based at least in part on the proportion.

11. The method of claim 10, wherein determining whether to identify the client as a malicious client comprises: comparing the proportion to a threshold value and identifying the client as a malicious client if the proportion exceeds the threshold value.

12. The method of claim 9, wherein said determining is performed using machine learning.

13. The method of claim 9, wherein the plurality of messages are, collectively, directed to a plurality of applications.

14. The method of claim 9, wherein the traffic comprises application layer messages.

15. The method of claim 9, wherein the traffic comprises HTTP requests.

16. The method of claim 9, further comprising: determining a client reputation score for the client based at least in part on the client's use of characters as reflected in the set of interest in the plurality of message logs.

17. Apparatus for identifying malicious clients on a computer network, comprising:
one or more computing machines, each having at least one microprocessor and memory storing instructions for execution by the at least one microprocessor, the execution of the instructions causing the one or more machines to:
define a set of characters as a set of interest, the set of interest being associated with one or more attacks;
receive a plurality of messages from a client over a computer network;
determine whether to identify the client as a malicious client based at least in part on the client's use of characters in the set of interest in the plurality of messages.

18. The apparatus of claim 17, wherein the execution of the instructions causes the one or more machines to:
examine the plurality of messages sent by the client to determine the proportion of messages that each contain at least a predetermined number of characters from the set of interest;
determine whether to identify the client as a malicious client based at least in part on the proportion.

19. The apparatus of claim 18, wherein determining whether to identify the client as a malicious client comprises: comparing the proportion to a threshold value and identifying the client as a malicious client if the proportion exceeds the threshold value.

20. The apparatus of claim 17, wherein said determining is performed using machine learning.

21. The apparatus of claim 17, wherein the plurality of messages are, collectively, directed to a plurality of applications.

22. The apparatus of claim 17, wherein the plurality of messages comprises application layer messages.

23. The apparatus of claim 17, wherein the plurality of messages comprises HTTP requests.

24. The apparatus of claim 17, the execution of the instructions causing the one or more machines to: determine a client reputation score for the client based at least in part on the client's use of characters in the set of interest in the plurality of messages.

25. Apparatus for identifying malicious clients on a computer network, comprising:
one or more computing machines, each having at least one microprocessor and memory storing instructions for execution by the at least one microprocessor, the execution of the instructions causing the one or more machines to:
define a set of characters as a set of interest, the set of interest being associated with one or more attacks;
receive a plurality of message logs reflecting traffic sent by a client over a computer network;
determine whether to identify the client as a malicious client based at least in part on the client's use of characters in the set of interest as reflected in the plurality of message logs.

26. The apparatus of claim 25, wherein the execution of the instructions causes the one or more machines to:
examine the plurality of message logs to determine the proportion of messages that each contain at least a predetermined number of characters from the set of interest;
determining whether to identify the client as a malicious client based at least in part on the proportion.

27. The apparatus of claim 26, wherein determining whether to identify the client as a malicious client comprises: comparing the proportion to a threshold value and identifying the client as a malicious client if the proportion exceeds the threshold value.

28. The apparatus of claim 25, wherein said determining is performed using machine learning.

29. The apparatus of claim 25, wherein the plurality of messages are, collectively, directed to a plurality of applications.

30. The apparatus of claim 25, wherein the traffic comprises application layer messages.

31. The apparatus of claim 25, wherein the traffic comprises HTTP requests.

32. The apparatus of claim 25, the execution of the instructions causing the one or more machines to: determining a client reputation score for the client based at least in part on the client's use of characters in the set of interest as reflected in the plurality of message logs.

33-48. (canceled)
